(19) United States
(12) Patent Application Publication
(10) Pub. No.: US 2011/0226099 A1
(43) Pub. Date: Sep. 22, 2011

(54) Mechanism for adjusting pivot angle of socket of socket wrench

(76) Inventor: Kuo Lung Chen, Taichung (TW)

(21) Appl. No.: 12/727,208

(22) Filed: Mar. 18, 2010

(51) Int. Cl. B25B 23/16

(52) U.S. Cl. 81/177.8

(57) ABSTRACT

A socket wrench includes a handle having a bifurcated head including a blind hole spaced from bottom and a channel having both ends communicating with the blind hole and a space defined by the head respectively; a spring depressible trigger pin disposed in the blind hole and having a first inclined surface, a second inclined surface, and a straight line joining the first and second inclined surfaces; a lock pin slidably disposed in the channel and having a first garbled member at one end, the first garbled member including a tip edge, and a second garbled member at the other end, the second garbled member having a tip edge urged against the second inclined surface; and a socket having a projection pivotably disposed in the handle head, the projection including an arcuate toothed section being in gear engagement with the tip edge of the first garbled member.

### BACKGROUND OF THE INVENTION

1. Field of Invention

The invention relates to socket wrenches and more particularly to a mechanism for adjusting pivot angle of a pivotal socket of a socket wrench with improved characteristics.

2. Description of Related Art

Socket wrenches with pivotal socket are well known in the art. However, a couple of drawbacks have been found in various socket wrenches. For example, engagement of some components is not reliable. Also, malfunction often occurs. Thus, the need for improvement still exists.

### SUMMARY OF THE INVENTION

It is therefore one object of the invention to provide a socket wrench comprising a handle comprising a bifurcated head including a blind hole spaced from bottom and a channel having both ends communicating with the blind hole and a space defined by the head respectively; a spring depressible trigger pin disposed in the blind hole and comprising a first inclined surface, a second inclined surface, and a straight line joining the first and second inclined surfaces; a lock pin slidably disposed in the channel and comprising a first garbled member at one end, the first garbled member including a tip edge, and a second garbled member at the other end, the second garbled member having a tip edge urged against the second inclined surface; and a socket comprising a projection pivotably disposed in the head of the handle, the projection including an arcuate toothed section being in gear engagement with the tip edge of the first garbled member, whereby pressing the trigger pin to slide the tip edge of the second garbled member along the first inclined surface until being stopped at the straight line will disengage the tip edge of the first garbled member from the toothed section.

The above and other objects, features and advantages of the invention will become apparent from the following detailed description taken with the accompanying drawings.

### BRIEF DESCRIPTION OF THE DRAWINGS

FIG. 1 is a perspective view of the head portion of a socket wrench according to the invention;

FIG. 2 is an exploded view of FIG. 1;

FIG. 3 is a sectional view of the socket wrench of FIG. 1;

FIG. 4 is another sectional view of the socket wrench of FIG. 1;

FIG. 5 is a view similar to FIG. 3 showing a disengagement of the lock pin and the toothed section prior to pivot angle adjustment of the socket of the socket wrench; and

FIG. 6 is a view similar to FIG. 4 showing the disengagement of FIG. 5.

### DETAILED DESCRIPTION OF THE INVENTION

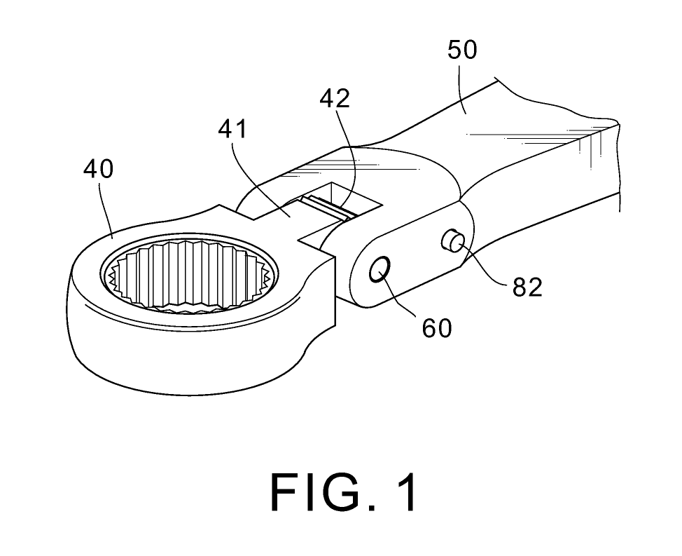

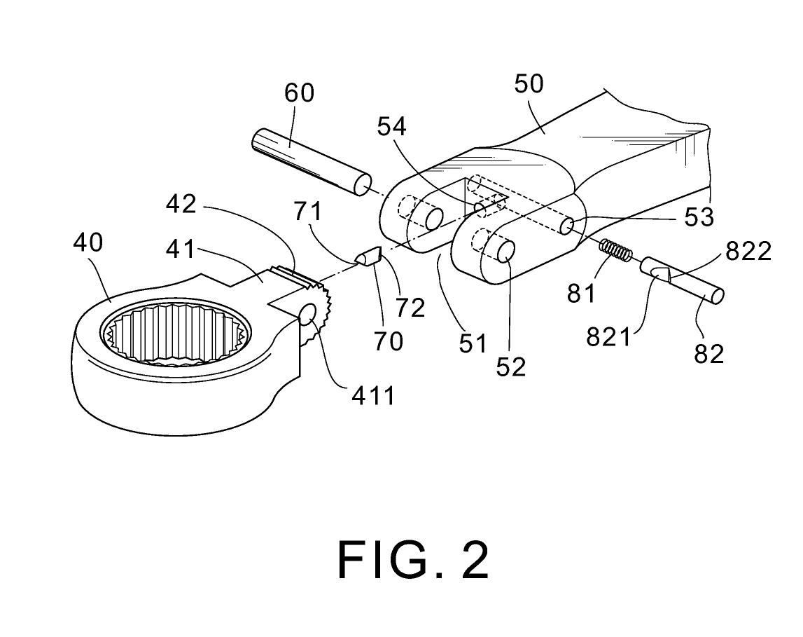

Referring to FIGS. 1 to 6, a socket wrench in accordance with the invention comprises the following components as discussed in detail below.

A handle 50 comprises a bifurcated head 51 having a hole 52 through both arms, a blind hole 53 spaced from bottom of the head 51, and a channel 54 having both ends communicating with the blind hole 53 and a space defined by the head 51 respectively.

A trigger pin 82 is slidably disposed in the blind hole 53 with a helical spring 81 biased between bottom of the trigger pin 82 and bottom of the blind hole 53. The trigger pin 82 has a first inclined surface 821 and a second inclined surface 822 both on its cylindrical surface. The first and second inclined surfaces 821, 822 are joined at a straight line 823 and together form a cut. Note that the first inclined surface 821 has a slope different from that of the second inclined surface 822.

A short, cylindrical lock pin 70 has a first garbled member 71 at one end and a second garbled member 72 at the other end. The first garbled member 71 is shaped the same as the second garbled member 72 except that its tip edge 711 is perpendicular to tip edge 721 of the second garbled member 72.

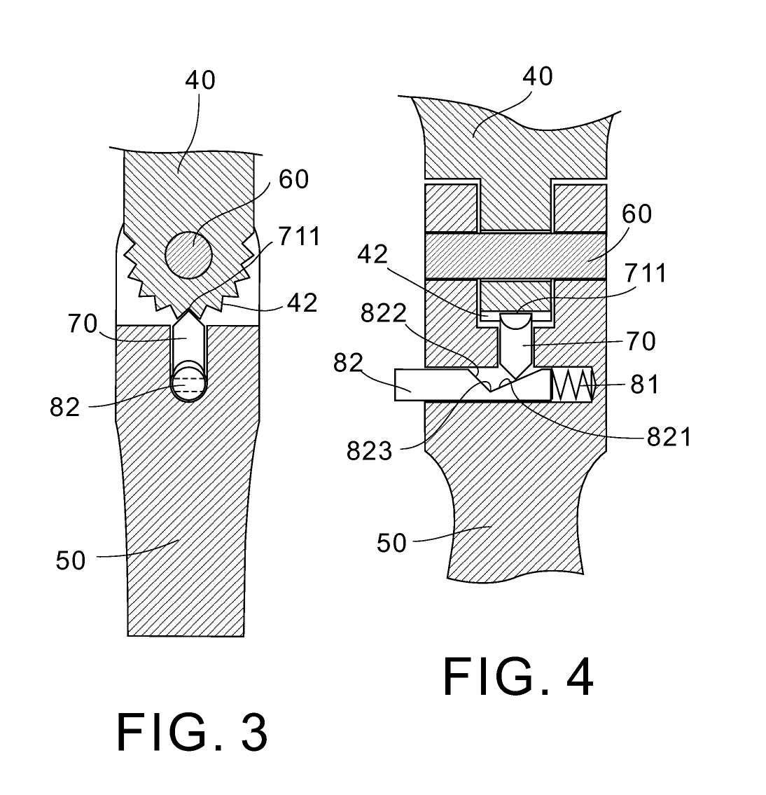

A socket 40 has a projection 41 facing the handle 50. The projection 41 has a transverse hole 411 and a toothed section 42 on the arcuate surface portion. A pivot pin 60 is inserted through the hole 52 and the hole 411 to pivotably secure the socket 40 and the lock pin 80 together. The lock pin 70 is disposed in the channel 54 with the tip edge 721 of the second garbled member 72 urged against the second inclined surface 822 and the tip edge 711 of the first garbled member 71 in gear mesh with the tooth of the toothed section 42. This completes the assembly of the socket wrench (see FIGS. 3 and 4).

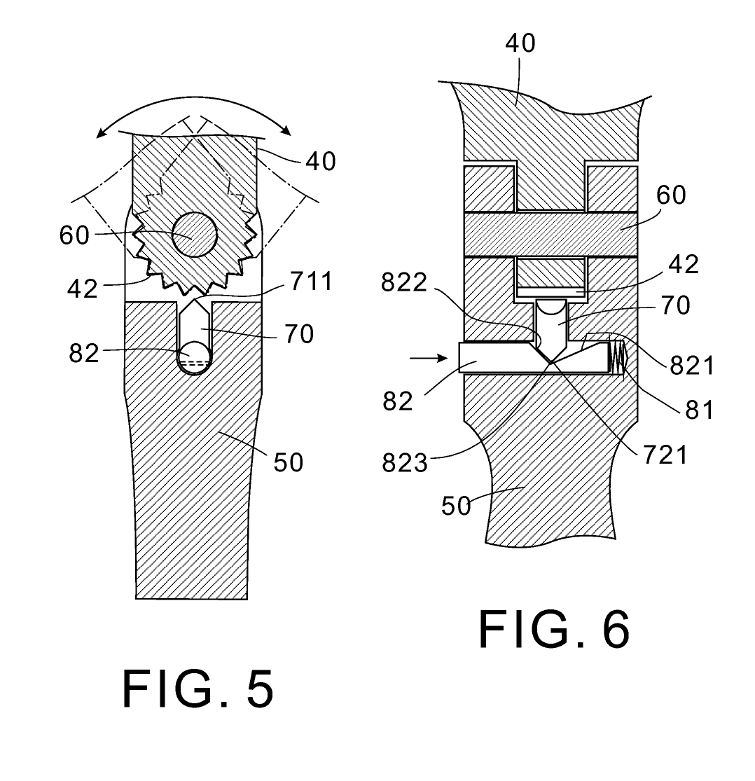

For adjusting pivot angle of the socket 40 of the socket wrench, a user may first press the trigger pin 82 to slide the tip edge 721 of the second garbled member 72 along the first inclined surface 821 until it is stopped at the straight line 823. Also, the spring 82 is compressed and the tip edge 711 of the first garbled member 71 is disengaged from the tooth of the toothed section 42 (see FIGS. 5 and 6). Thereafter, the user may pivot the socket 40 until a desired inclined angle of the socket 40 with respect to the handle 50 is obtained.

While the invention herein disclosed has been described by means of specific embodiments, numerous modifications and variations could be made thereto by those skilled in the art without departing from the scope and spirit of the invention set forth in the claims.

What is claimed is:

1. A socket wrench comprising:
a handle comprising a bifurcated head including a blind hole spaced from bottom and a channel having both ends communicating with the blind hole and a space defined by the head respectively;
a spring depressible trigger pin disposed in the blind hole and comprising a first inclined surface, a second inclined surface, and a straight line joining the first and second inclined surfaces;
a lock pin slidably disposed in the channel and comprising a first garbled member at one end, the first garbled member including a tip edge, and a second garbled member at the other end, the second garbled member having a tip edge urged against the second inclined surface; and
a socket comprising a projection pivotably disposed in the head of the handle, the projection including an arcuate toothed section being in gear engagement with the tip edge of the first garbled member,
whereby pressing the trigger pin to slide the tip edge of the second garbled member along the first inclined surface until being stopped at the straight line will disengage the tip edge of the first garbled member from the toothed section.

2. The socket wrench of claim 1, wherein the first inclined surface has a slope different from that of the second inclined surface.

3. The socket wrench of claim 1, wherein the tip edge of the first garbled member is perpendicular to the tip edge of the second garbled member.
